(19) United States
(12) Patent Application Publication
(10) Pub. No.: US 2006/0160687 A1
(43) Pub. Date: Jul. 20, 2006

(54) Method and device for rapid homogenisation and mass transport

(76) Inventors: Mats Malmqvist, Uppsala (SE); Nicke Svanvik, Stockholm (SE); Magnus Malmqvist, Uppsala (SE)

Correspondence Address: YOUNG & THOMPSON, 745 SOUTH 23RD STREET, 2ND FLOOR, ARLINGTON, VA, 22202, US

(21) Appl. No.: 10/535,427

(22) PCT Filed: Nov. 18, 2003
(86) PCT No.: PCT/SE03/01787

§ 371 Date: Dec. 9, 2005

(30) Foreign Application Priority Data
Nov. 19, 2002 (SE) 0203412-2
Jun. 24, 2003 (SE) 0301841-3

(51) Int. Cl. B04B 15/02

(52) U.S. Cl. 494/14; 422/209; 422/224

(57) ABSTRACT

Rapid mixing and homogenisation of reaction mixtures with respect to temperature and chemical concentrations, as well as greatly enhanced mass transport is achieved when the reaction mixture placed in a vassel suitable for centrifugation, and subjected to asymmetric heating, cooling and simultaneous centrifugation at conditions for creating an enhanced flow within the reaction mixture, wherein the flow ensures practically total mixing and homogenisation of the reaction mixture.

The present invention refers to the field of chemistry and biochemistry, and in particular the handling of reaction mixtures in liquid media where a rapid mixing and homogenisation with respect to both temperature and molecular concentration gradients in the reaction mixture is desired. It also refers to creating specific flow patterns inside a reaction vessel under centrifugation, heating and cooling, as well as to creating efficient mass transport between the bulk of a liquid and a solid phase, present in said liquid.

### BACKGROUND OF THE INVENTION

Many important industrial processes as well as procedures applied in laboratories of various kinds are dependent on chemical and biochemical reactions. Commonly the time consumed for completing a process or procedure is determined by the time it takes for a specific chemical reaction or reactions to reach equilibrium. This is often referred to as the kinetic properties of a chemical reaction or simply reaction kinetics. A host of variables influence the reaction kinetics in each case, for instance molecular properties and the concentrations of reactants, temperature, presence of catalytic agents etc.

Typically, increased temperature accelerates chemical reactions by speeding up key mechanisms like bringing molecules or molecule domains in contact with each other. Therefore it is common to heat the reaction vessels, for example bringing them in contact with an open flame, hot gas, hot liquid, hot sand or a solid material. This procedure is often referred to as incubation. In biochemical reactions, more sophisticated procedures are required to avoid irreversible denaturation of sensitive components upon heating.

One typical problem involved with incubations of fluid reaction mixtures is thermal heterogeneity, because the parts of the reaction mixture being in close contact with the walls of the reaction vessel will become heated before the more central parts of the reaction mixture. Frequently, there is a risk that part of the reaction mixture becomes overheated before other parts even reach the desired temperature. Further, in the absence of mixing or agitation, temperature gradients form in the reaction mixture. Hot subsets of the reaction mixture normally have lower density than cold subsets, which tend to generate temperature gradients or discrete layers of more or less isothermal bodies of liquid, so called thermoclines. Thus warm, less dense portions of the reaction mixture tend to find a position above cold, denser portions. Molecular motion and currents in the reaction mixture will eventually homogenize the reaction mixture with respect to temperature, a process here referred to as temperature homogenisation of the reaction mixture, or homogenisation with respect to the temperature. The time it takes to homogenise a reaction mixture with respect to the temperature may contribute substantially to the time required for the complete reaction.

However, time-consumption in itself is not the sole problem involved with temperature homogenisation of chemical reaction mixtures. In certain incubation procedures such as the repetitive temperature adjustments involved in so called thermocycling processes, e.g. for performing polymerase chain reactions, also known as PCR-reactions, long temperature homogenisation periods favour unwanted side-reactions, sometimes causing severe quality problems with respect to the accuracy-and specificity of the obtained PCR-product.

In an alternative amplification process, known as rolling-circle amplification (RCA), the thermocycling is replaced by one single temperature adjustment, followed by a prolonged incubation. In this application, it is important that the desired temperature is reached rapidly and with high accuracy within the entire sample volume, in order to avoid unspecific onset of the amplification process, and the formation of products, which will remain and be amplified during the incubation.

In the ongoing strive to miniaturize chemical reaction volumes, as evident e.g. in the field of high throughput screening (HTS), combinatorial chemistry etc., several other problems are encountered. In a small reaction vessel, such as a small test tube or a well on a microtitre plate, both the mixing and temperature homogenisation of sample and reagents may become severely restricted. When two or more miscible fluids are mixed, we normally assume that they first form a homogenous mixture, which then reacts. This is however rarely the case.

Assays for concentration determinations have a wide range of formats and configuration. Quite a few are based on solid phase immobilisation of one component in the binding assay and determination of the amount of analyte that can be detected on the particular surface. Of particular interest for all assay formats, and in particular solid phase assays, is a proper homogenisation and efficient mass transfer from a large volume to a defined ligand on the surface. With an increased focus on multiassays, an increased interest has been focused on array formats that effectively can analyse low concentrations of many analytes from one defined sample volume.

Conventional microtitre plates and cuvettes are often manufactured from polystyrene, a hydrophilic polymer. Without dwelling on the exact behaviour of the liquid at the vessel boundaries, it can be concluded that stagnant areas will form and insufficient mixing easily occur in a small reaction vessel, such as a well on a microtitre plate. The properties of the reactants and sample fluids also influence their interaction with each other and with the vessel boundaries. Partial segregation, the formation of layers, aggregation and so on, are only a few examples of irregularities that can be encountered in a reaction vessel.

There are reasons for distinguishing between two different phenomena causing problems with heterogeneous temperature distribution in a reaction mixture. The phenomena caused by the interaction between the fluid and the walls, appearing close to the walls of a reaction vessel is a problem, which increases when reaction scale decreases. In contrast, the phenomena involving central parts of the liquid body being colder than the liquid close to walls when heating a reaction vessel from the outside, increases when reaction scale increases. This is the reason why thermocycling devices for use in processes in which proper temperature homogenisation is required (e.g. processes like PCR), have a very narrow dynamic range with respect to the reaction scale as the surface to volume ratio has to be high. Typically, in PCR-reactions these problems are most severe when the reaction volumes are less than 5 μL or larger than 50 μL.

Another problem, seemingly unrelated to the mixing and temperature homogenisation issues, is that of evaporation. In order to minimize evaporation, there is a tendency that the reaction vessels, in particular the wells on microtitre plates, are made both deeper and more narrow. Naturally, this further enhances the previously mentioned problems of insufficient mixing and temperature homogenisation.

So far, temperature heterogeneity has been discussed in terms of properties in a single reaction vessel. Especially when discussing miniaturisation of multi-sample or parallel applications, such as assays, different applications in combinatorial chemistry, chemical synthesis, and HTS etc., yet another dimension of temperature heterogeneity needs to be considered; that of variation between individual reaction vessels. In assays with comparative purposes (i.e. with or without quantitative analysis like screening for novel drug candidates, mutations in nucleic acids, single nucleotide polymorphism and so forth) it is important to consider the reproducibility, commonly referred to as well-to-well uniformity.

Since the mechanisms behind poor thermal uniformity are difficult to describe and simulate accurately, the only available solution to the problem is often to focus on means to enhance the homogenisation processes. To do this, various strategies are applied. Mechanical agitation is perhaps the most commonly employed method, this agitation including both stirrers in the reaction mixture, as well as agitation of the entire reaction vessel. Ultrasound is another often used method to perform agitation and still another method is to force the reaction mixture to pass a defined area repeatedly, e.g. by pumping the reaction mixture through a fluid channel or cell, in which reagents or analytes are immobilised.

The mass transport of chemical reagents or biochemical components in the volume is of vital importance to achieve reproducibility and uniform conditions in the volume. Mass transport is also of vital importance in solid phase assays or synthetic situations, where material has to be transferred from the bulk of a fluid to a solid surface over the diffusion limited stagnant layer of said fluid. This is a limiting factor for speed and sensitivity of most ligand binding assays.

The problems underlying the invention can be easily derived from the state of the art, considering the above introduction read with the knowledge of a person skilled in the art.

### PRIOR ART

WO 98/49340 (PCT/AU98/00277) discloses a temperature cycling device and method where a reaction mixture and a sample is loaded into loading wells on a disposable rotor, which rotor is then placed into a centrifugal thermal cycling device and spun, so that the reaction mixture and sample are moved by centrifugal force to a reaction well at the periphery of the rotor. The device comprises heating means, for example infrared lights, convection heating elements or microwave sources. Interestingly, also provisions for cooling the rotor are included in the specification. According to one embodiment, the rotor speed is increased, resulting in air being drawn into the device and rapidly cooling the contents of the reaction chambers at the periphery of the rotor. In addition to ambient air, a coolant gas can be used. Refrigerated air is given as an example of coolant gases. Importantly, the disclosure of WO 98/49340 implies the use of different speeds of rotation. Further, WO 98/49340 does not address the problems of mixing and homogenous temperature. For example, it does not specify the direction of heating, nor does it contemplate simultaneous heating and cooling.

DE 19501105 A1 discloses a centrifuge with a temperature control system where a circulating fluid enters the rotor from above and flows outwards and downwards in the direction of the radius, around the test tubes or sample containers. The inventor of the centrifuge according to DE 19501105 criticises the hitherto known devices using a radiating source of heat and rejects them as unsatisfactory.

WO 00/58013 of the present applicant describes a method and device for simultaneous centrifugation and heating and optionally cooling of samples.

### SUMMARY OF THE INVENTION

The present inventors have surprisingly found that controlled and highly effective mixing and homogenisation, both with regard to temperature and to molecular concentrations, is achieved when the reaction mixture placed in a vessel suitable for centrifugation, and subjected to asymmetric heating, cooling and simultaneous centrifugation at conditions for creating a controlled flow within said reaction mixture, wherein said flow ensures practically total mixing and homogenisation of the reaction mixture.

One important advantage of the rapid mixing and homogenisation of the present invention is that it is non-invasive in the sense that no impellers, stirrers or other devices need to be brought in contact with the reaction mixture. Another important advantage is that the rapid mixing and homogenisation appears to be independent of the reaction volume, that is the desired result is achieved both in microscopic and macroscopic reaction volumes.

Another important aspect of the invention is the unexpected flow pattern of liquid in the vessel and the high linear flow rate. A laminar flow is created in close proximity to the surface of the vial and this will considerably improve the mass transport from the bulk volume to the surface.

Of particular interest is a special section of the vessel, said section defined by the rotation, where the fluid flows in the direction of the g-force, and where the total volume of the fluid will pass repeatedly over a limited surface area during the centrifugation period. Consequently, high mass transport is favoured, in combination with a high degree of recirculation over a defined area.

The present invention makes available an improved reaction vessel according to the attached claims, incorporated herein by reference.

### BRIEF DESCRIPTION OF THE FIGURES

The invention will be described in closer detail in the following description, examples, and attached drawings, in which

FIG. 1 schematically illustrates the flow in a reaction vessel 1 during the conditions created according to the present invention (superconvection). The direction of the gravitational force, create by the centrifugation; is indicated by the arrow “g”. The upward flow in the reaction vessel is illustrated by the light arrows A, and the surface-oriented flow by the filled arrows B.

FIG. 2 shows the reaction vessel of FIG. 1 from above, the upward and surface-oriented flow being the same, illustrated by arrows A and B, respectively. The direction of the gravitational force is again indicated by “g”, now pointing into the plane. Additionally, a downward flow or a local “sink” is indicated as C in contact with the vessel surface. Further, the arrow “v” indicates the direction of rotation during centrifugation.

FIG. 3a shows an embodiment of the invention, where a reaction vessel 1 is designed to take advantage of the flow pattern achieved. Local means, capable of interaction with at least one component of the reaction mixture, are positioned as discrete dots or spots 2, 3, 4 and 5 in the area of the sink.

FIG. 3b shows another embodiment, where a reaction vessel 1 has local means 6, 7, and 8 positioned in the shape of elongated areas intersecting with the sink.

FIG. 3c shows a third embodiment, where said local means, here shown as 10, 11, 12, and 13, are positioned on an insert 9, preferably adapted to the geometry of the reaction vessel 1 and insertable therein so that said means will become positioned in the area of the sink.

FIG. 4 illustrates in the form of an example, how a reaction vessel 1 can be designed having specific geometrical features, 14 corresponding to features of a rotor 16, so that the correct orientation of the individual vessels can be ensured.

### DESCRIPTION

In the following description of the invention, certain definitions will be used. They are to be interpreted as outlined below:

The terms “gravitation”, “gravitational field” and “direction of the gravitational field” are described with vectors, the direction of the gravitation field being the same as the resulting vector when a vector representing the centrifugal force, that is a vector at right angle to the axis of the centrifuge rotor directed from the centre of the rotor, is added to the vector representing the earth gravity. Consequently, downwards is in the present text defined as the same direction as the gravitation field as defined by the summed vectors representing centrifugal force and gravitation.

The term “reaction mixture” means any fluid reaction mixture, preferably a liquid reaction mixture, in which the reaction kinetics is influenced by temperature and where a faster, more efficient and homogenous temperature adjustment is desired. A non-exhaustive list of examples of reactions, suitable for the present device and method are chemical/biochemical reactions within the field of chemical synthesis, combinatorial chemistry, high throughput screening, assays, methods for the determination of the presence of or the concentration of a given substance, and biochemical reactions involving incubation or temperature adjustments, e.g. repeated temperature adjustments, cyclic temperature changes, including a polymerase chain reaction (PCR), a ligase chain reaction (LCR), a “gapped-LCR-reaction”, a nucleic acid sequence-based amplification (NASBA), a self-sustained replication (3SR), a transcription mediated amplification (TMA), a stand displacement amplification (SDA), a target amplification, a signal amplification, rolling-circle amplification (RCA), or a combination of any of the above.

Typically a polymerase chain reaction involves the following steps:

1) Preparation of the reaction mixtures, i.e. preparation of the samples to be tested;

2) Amplification, i.e. the exponential replication of the DNA molecules; and

3) Detection of specific sequences for example by electrophoresis or hybridisation.

This outlined principle is applicable, mutatis mutandis, to many of the above reactions. In conventional PCR, step 2) involves repeated temperature changes to take the reaction mixture through the steps of annealing and extension of the nucleotide strands. Inefficient temperature homogenisation, e.g. diffuse temperatures and temperature gradients in the reaction mixture, leads to unspecific amplification products. The necessity of a fast and homogenisation with respect to temperature is central for the quality and reliability of the reaction. Further, an effective mass transport within the sample, and between components thereof, is equally important.

The term “assay” in the above encompasses all forms of assays, such as homogenous and heterogeneous assays, binding assays, solid phase assays, particular examples including—but not limited to—ELISA assays, immunoassays, enzyme-based assays, non-labelled assays, affinity assays, fluorescence assays etc.

The term “reaction-vessel” means any vessel capable of containing a reaction mixture within a temperature range necessary for performing the desired reaction/reactions. Examples of reaction vessels suitable for use according to the invention include, but are not limited to, the following: test tubes, so called micro tubes, Eppendorf-tubes, a single well or a multitude of wells in a microtitre plate, such as a microtitre plate of the 96-hole format, and various formats with a high density arrays of wells, such as the 192-hole format, the 384-hole format, denser formats or the like. Further examples of reaction vessels include flow channels, cells and volumes, defined in a device such as disc or other device, suitable for rotating, e.g. the analysis platform corresponding to the conventional CD-format. The reaction vessel for use according to the present invention can be a conventional, commercially obtainable reaction vessel as listed above, or a reaction vessel specially adapted for use according to the invention.

The term “asymmetric” as in “asymmetric heating and cooling” refers to heating and cooling acting only on subsets of the reaction volume in a reaction vessel.

The terms “controlled flow” and “enhanced flow” are used to define the non-intuitive flow created in a reaction vessel according to the present invention. A flow is controlled or enhanced when it differs from the flow normally present (if any) in a reaction vessel subjected to either to heating only, cooling only, or centrifugation only. A flow is also held to be controlled or enhanced when said flow, it direction, speed, orientation or other properties are deliberately influenced.

The present inventors have surprisingly found that extremely rapid mixing can be achieved when a reaction mixture is subjected to simultaneous heating and cooling during the influence of a centrifugal force. This extremely rapid mixing is tentatively called superconvection. Importantly, it has been shown that this mixing is achieved already at small temperature differences within the reaction mixture.

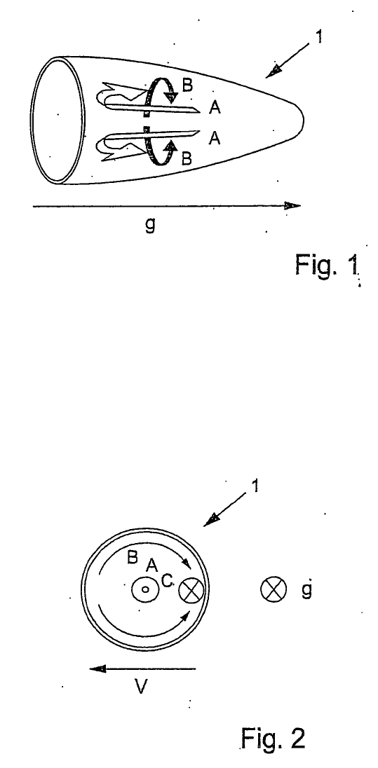

The rapid mixing, mass transport and temperature homogenisation, achieved under the conditions developed by the inventors, is driven by changes in density in the liquid based on asymmetric heating/cooling effects and the Coriolis' effect due to rotation of the entire volume during the centrifugation. This in combination give rises to extremely high liquid streaming which in turn homogenises the reaction mixture both with respect to temperature and differences in substance concentrations within the entire vessel volume. The present invention creates a non-intuitive flow along the side walls of the tube in thin layers and a steep channel of liquid flow in the direction of the g-forces in a discrete position in the reaction vessel, said position being defined by the direction of the rotation. This will be called “the sink” in the following description and examples. Surprisingly, the flow along the sidewall appears to first take place horizontally, on both sides of the vessel, until it reaches the sink, where it turns downward. The flow pattern achieved according to the present invention is schematically shown in FIG. 1 and 2.

It is very surprising to note, that the surface-oriented flow takes the form of extremely thin layers. This has particular advantages. Thin layer flow of liquid gives new properties to the system in relation to mixing of the volume. The mass transfer characteristics for a thin-layer cell are well known, and it has now been shown by the present inventors that superconvection involves a flow of liquid, similar to that of a thin-layer cell, occurring along the cell walls. However, the linear flow rate has been estimated to be in the range of m/s according to theoretical calculations dependent on temperature difference and centrifugation speed. This very surprising finding should be compared with the results obtained with conventional flow-based instruments, where at a normal flow rate of 15 microliter per min the linear flow rate is in the order of 10 mm/s in a 50 micro-meter high flow cell. This shows that superconvection as achieved by the present invention results in 10 to 100 fold higher flow rates. Consequently, the mass transfer is much more effective than pumping liquid through a cell for surface uptake or liquid transport by electroendosmotic effects.

As superconvection according to the present invention takes place in a reaction vessel with a fixed volume, it follows that the entire volume will repeatedly pass the surface area and the total transfer of material from the volume to the surface becomes very effective. This is an important advantage not least for highly sensitive assays where the concentration of analyte is very low.

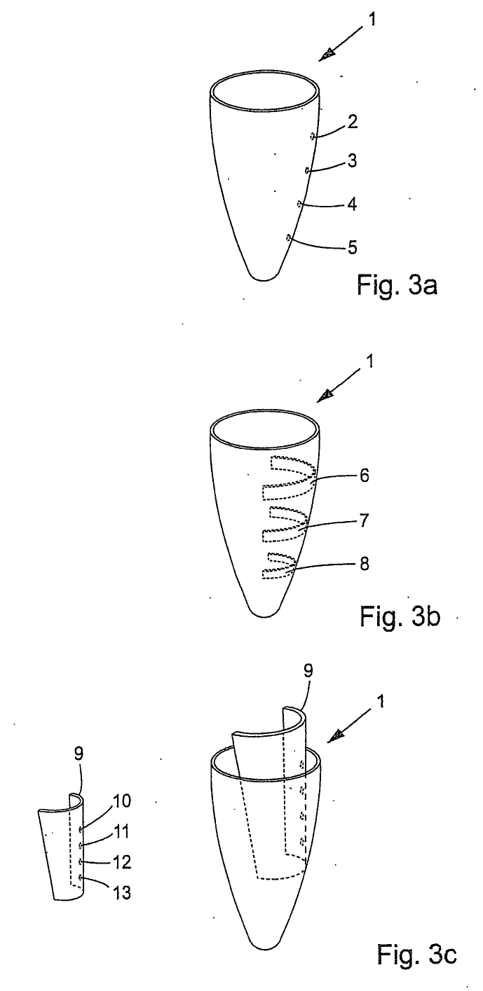

One aspect of the present invention is to take advantage of this flow pattern by positioning means capable of interaction with at least one component of the reaction mixture at locations, determined by said flow pattern. According to this aspect of the invention, said means are positioned in the area of the sink, or intersecting the downward flow in said area. See FIGS. 3a and 3b. Another embodiment involves the positioning of said means, capable of interaction with at least one component of the reaction mixture, on an insert, suitable for insertion in the reaction vessel. See FIG. 3c. When designing such inserts, and optionally also the reaction vessels that receive them, care should be taken to ensure that the final orientation of said insert in the reaction vessel corresponds to that of the sink.

According to one embodiment of the above aspect of the invention, said means capable of interaction with at least one component of the reaction mixture are small surface areas for adsorption of analyte from the liquid. As the entire volume will pass over a specific surface area several times, it is possible to immobilise a ligand on a specific, very small part of the surface, either on the walls or in the particular area which effectively will work as a sink. In many assay configurations it is important to transfer as much analyte as possible from the volume to a small surface area to reduce noise from background in the detection step. The volume that passes over a small spot during the analysis often limits this. The effective mass transport of analyte from the solution to the surface for adsorption becomes a limiting factor.

According to another embodiment of this aspect of the invention, said means capable of interaction with at least one component of the reaction mixture, are means for facilitating the detection of a component or the determination of a property of the reaction mixture. Reaction vessels having such means are then used together with detection methods that focus on selected areas inside the vessel, such as confocal microscopy or any other related or equivalent technology. High surface concentration in small spots will facilitate the detection.

According to another embodiment of this aspect of the invention, said means capable of interaction with at least one component of the reaction mixture, are means having structured surfaces where each surface entity has one analyte specificity. In this way addressing and multi-analysis in one vessel can take place, even when the chemical environment is the same under all assay conditions. The sink part of the reaction vessel is in this aspect a point for orientation of the tube in the used assay where conditions are different regarding flow properties in comparison with the rest of the vessel. This is the place where all liquid from the bulk passes as a thin stream of liquid several times. The size of the means capable of interaction with at least one component of the reaction mixture, here the analyte specific areas, can vary considerably. This depends on many different aspects, including the nature of the detection step performed after the effective superconvection controlled adsorption has taken place. The detection and subsequent steps do not necessarily have to be performed under centrifugation as long as the analyte has been concentrated to a small area, e.g. on patterned surfaces, during the rapid mixing and homogenisation achieved by the present invention. The rapid mixing and homogenisation according to the invention may be only one step of the full assay procedure.

This aspect of the invention gives the user the freedom to address the sink part with a series of analyte specific small areas or arrays, knowing that the entire volume of reaction mixture will pass these areas with the maximal speed. These means or here surface areas that can be addressed can be as small as the detection and addressing technology allows. This embodiment has the advantage of improving the sensitivity of an assay, by adsorbing a low concentration from a large volume of sample to a very small surface area. Another aspect is to use the same analyte specificity in the sink part as well as other parts of the wall where the flow rate is different. This will give different mass transfer properties and thus cover different part of the assay concentration range.

Another embodiment based on this aspect of the invention is the possibility to create arrays of particles, reagents etc. in different locations on the surface of the vessel. These can, as discussed above, be located in the area of the sink, or in the vicinity of said area. These arrays, or individual spots or dots or areas having particular properties, can also be located at other places on the inner surface of the reaction vessel, based on knowledge of the flow pattern and the desired interaction between said arrays, dots, spots or areas, and the reaction mixture.

Still another aspect of the present invention, based on the high flow rates encountered in thin layers close to the surface of the reaction vessel, is to create a pattern on the inner surface of the reaction vessel in such a way that the laminar flow is disturbed. According to his, the means capable of interaction with at least one component of the reaction mixture are means interacting physically or mechanically with the flow. The mass transport under such conditions can be varied as desired, dependent on the centrifugation speed and flow characteristics close to the surface and the pattern on the surface. Such flow disturbances induced on the surface can be combined with chemical patterns to induce optimal mass transfer to particular areas on the surface, for example areas to which defined ligands are immobilised. According to an embodiment of this aspect of the invention, the flow characteristics can be influenced, either in the reaction vessel as a whole, or in selected areas thereof, by adding specific topographical features to the inner surface, said features interfering with the laminar, surface-oriented flow. Said features can be arranged randomly, in a specific area, but are preferably arranged in the form of an ordered array.

In addition to the above, said means capable of interaction with a component or property of the reaction mixture, can be means chosen among mechanical means interacting with the flow, such as means guiding the flow, causing turbulence etc, means for transferring heat, means for guiding light or radiation, arrays or particles or substances, defined areas, dots or spots with a chemical or biochemical component which interacts with a component in the reaction mixture etc.

The present invention can be applied to chemical synthesis. Chemical synthesis is a major bottleneck in the search for new drug candidates in pharmaceutical development. Rapid synthesis and reduction of impurities are important aspects as well as the parallel processing of synthesis. This finds application for example in HTS and in combinatorial chemistry. One method of chemical synthesis involves microwave heating and magnetic stirring. The heating process is effective but the magnetic stirring is unsatisfactory, as it gives rise to temperature gradients inside in the vessels, e.g. so called hot spots. This is valid both for the heating phase but even more so for the cooling phase. The temperatures vary, but temperatures up to 200° C. are used and the synthesis may take place under high pressure in many different solvents.

Another aspect of chemical synthesis is the rapid cooling, necessary to avoid side reactions after the main product has been formed. In some situations, there is a need to cool the reaction while it takes place, although this is less frequent. The rapid heating and cooling procedures can be of vital importance for the outcome of the reaction. However, with the presently available technology, the stirring and mixing processes become limiting factors. According to one leading actor in this field, the time to reach working temperature was 50 s for a reaction time of 30 s at 140° C. Correspondingly, about 70 s was required to cool the same reaction mixture to about 50° C. Microwave technology has taken traditional chemical synthesis into a new era. However, it has not solved the important aspect of temperature gradients formed during heating and especially during cooling, which seems to be passive diffusion of heat over relatively long distances in combination with magnetic stirring. The microwave absorption characteristics are notoriously difficult to control, but modern synthesis instrumentation can give a much better distribution of heat than traditional microwave technology. Still the temperature in the reaction mixture is frequently inhomogeneous. Further, it is clear that it still takes relatively long to approach the desired reaction temperature, particularly as it is important not to exceed the same. As a result, the time to reach a desired temperature is much longer than what would be optimal from the point of controlled synthesis. Also the cooling is inefficient, and the time needed to reach a reasonable temperature is 2-3 times longer than the reaction time at the desired temperature. It is easily seen that such conditions are less than optimal.

According to one aspect of the present invention, the rapid mixing and homogenisation according to the invention is used to reduce the time for heating and cooling in chemical synthesis applications. This will dramatically decrease the time for a complete synthesis. Further, the amount of impurities formed at non-optimal temperature levels becomes lower due to the rapid mixing and homogenisation with regard to temperature. This is a considerable and surprising advantage of the present invention. Further, the size of the reaction volume can be varied within a large interval, both up as well as down, towards the microliter range. In particular the microliter to sub microliter range is of interest when it is desired to reduce the amount of chemical solvents and reagents.

The method according to the present invention will also increase the mass transport of chemical reagent in the synthesis volume, as there will be effective mixing also under the reaction period at desired temperature due to the asymmetric heating. This is a surprising aspect of the invention, as it has been shown that the rapid mixing and homogenisation takes places already at very small temperature differences in the reaction mixture. This is valuable in applications, where the requirements for temperature accuracy are high, and in particular in such applications where a given temperature limit may not be exceed.

There are several examples in the literature on microwave assisted chemical synthesis and one overview can be Larhed, M., Hallberg, A. Drug Discovery Today 2001, 6, 385-395. It is conceived that the inventive method can be applied to improve any of these. The present invention makes available methods and devices for use in these applications.

One particular embodiment of the above aspect of the invention relates to solid phase chemical synthesis. One advantage of the inventive method is the distribution of flow along the surface of the reaction vessel in the form of a parallel laminar flow. This results in an effective mass transfer of substance between the bulk and the surface. This can also be used e.g. for solid phase synthesis, which is routinely used for synthesis of peptide and nucleic acids. Traditionally such synthesis methods are based on the use of beads in order to improve surface to volume properties. However, for analytical applications it is often more convenient to apply the synthesis in the same reaction vessel as where the analysis takes place. Sequential steps with alternating washing and reagent addition are necessary to build polymers on the surface of the vessel. According to the invention, the rapid mixing and homogenisation achieved by simultaneous, asymmetric heating and cooling is applied to solid phase synthesis.

A centrifugation based method and/or system has the added advantage that reagent cartridges, such as CAPILETTE® (ALPHAHELIX AB, Uppsala, Sweden) can be used for reagent addition. When the reactions are sequential, washing steps have to be introduced. In some situations an effective immobilisation of ready-made polymers can be a better alternative, and to this end, the application of the inventive method of rapid mixing and homogenisation and in particular the surface-oriented rapid flow will be advantageous.

Another aspect of the present invention relates to homogenous immunoassays, and the present invention makes available methods and devices for such assays. In this context, the term “device” includes both platforms for the performance of such assays, as well as components thereof, reaction vessels, multi-sample plates, and devices handling such components, as well as kits comprising such components and reagents.

Consequently, another aspect of the rapid and effective mixing according to the present invention is the application in assays, such as binding assays, solid phase assays, immunoassays or any other receptor based assay. In this context, the term receptor based assay comprises assays based on all types of receptors, such as membrane bound receptors, soluble receptors, lectins, antibodies, fragments of antibodies, peptides, and synthetic receptor molecules.

The present invention also finds utility in rapid temperature inactivation in assays and synthetic processes, and the present invention makes available methods and devices for such assays and processes. In PCR and PCR-related applications, it is a major benefit if temperature ramping could be performed more quickly and accurately than presently is the case. The present invention when applied here results n considerable improvements. It should be noted, that in PCR, the increase in temperature is used as a step for denaturation of the DNA. This denaturation effect can be used in several other applications, where one component has to find its maximum activity or where components need to be inactivated. Compared to nucleic acids, enzymes and other proteins often have a relatively low temperature optimum for activity before they are inactivate by thermal denaturation. In many assay procedures, a component (e.g. proteases) needs to be inactivated before the addition of reagents. Heat inactivation of components in the sample is often used before performing the assay, and complement inactivation in serum is a standard procedure. The present invention can advantageously be applied to the above steps.

According to one embodiment of the above aspect of the present invention, heat inactivation of components in reaction-mixtures can be integrated in one and the same procedure using the rapid mixing and homogenisation achieved by asymmetric heating and cooling during centrifugation. This has considerable advantages, as it will reduce time and the amount of handling steps in the assay. Heat inactivation using the invention can also be used to stop the activity of added components in the assay, and by using different systems such as heat stable or heat labile components from various sources, the inactivation can also be performed in sequence with increased stability and denaturation temperature. Examples of this can be heat labile UTNG in RT-PCR assays to perform one tube amplification.

The present invention is also advantageously applied to the field of solid phase assays and the present invention makes available methods and devices for such assays. In this context, the term “device” includes both platforms for the performance of such assays, as well as components thereof, reaction vessels, multi-sample plates, and devices handling such components, as well as kits comprising such components.

Solid phase immunoassays or any other receptor-based assays are either of competitive or sandwich type. There is a trend towards more homogenous assays as they are more effective with respect to mixing and mass transport than solid phase assays. However, solid phase assays often give higher sensitivity, better resolution and larger concentration range in the analytical procedures. One particular problem of solid phase assays is the mixing and mass transport of reagents and analytes to the surface of the vial. The application of the present invention to such assays will reduce the time for incubation of solid phase assays of competitive or sandwich type, due to the rapid flow along the walls of the reaction vessel. Another advantage will be greatly increased sensitivity of the assay.

According to one embodiment of the above aspect of the invention, one component in the assay is immobilised on the wall of the reaction vessel. The rapid mass transport of analyte to the surface achieved by the present invention will reduce the time needed for the assay. A large concentration range can be obtained, as the measurements can be performed on the walls and on the sink part of the reaction vessel where mass transport is different. It is possible to vary not only the affinity and other properties of the binding molecule, but also to vary surface concentration of both binding molecule and flow properties in the same vessel during the same assay procedure.

In sandwich assays, the reagents are added in series separated by washing procedures. It is also possible to use the rapid mixing and homogenisation according to the invention as well as a heating step to inactivate molecules in an assay as long as other components have different temperature stability. In a centrifugation based system, reagent cartridges, such as CAPILETTE® (ALPHAHELIX AB, Uppsala, Sweden) can be used to distribute new reagents at a desired time and temperature.

As a general aspect of the present invention, it becomes possible to design devices for performing reactions in fluid media, where the rapid mixing and homogenisation achieved by asymmetric heating and cooling during centrifugation, as well as the surprising flow pattern inside the reaction vessel plays a role. Previously in this description, reaction vessels have been mentioned. Such reaction vessels are, according to the invention, designed to make use of the flow pattern, or example by designing the entire shape of the reaction vessel in such manner as to emphasis or take advantage of said flow pattern. It is also conceived that the reaction vessel is designed so as to facilitate or increase the effects of asymmetric heating or cooling. Examples include vessels having internal or external means interacting with means for heating and/or cooling, e.g. external fins dissipating the heat from the reaction vessel and increasing the cooling effect on the rotating vessels. Another embodiment, also dwelled upon previously in the description, includes internal means, capable of interaction with at least one component of the reaction mixture, positioned inside the reaction vessel, in locations determined by the flow pattern. A preferred location is in the area of the sink, as the entire volume of the reaction mixture will pass here during the rapid mixing and homogenisation. Further, the reaction vessel itself may be provided with a particular shape or added features, corresponding to a shape or features of the rotor of a device capable of asymmetric heating, cooling and centrifugation, the shape or feature ensuring the correct positioning of the reaction vessel in said rotor with respect to the direction of rotation, as well as the direction of the gravitational force during centrifugation.

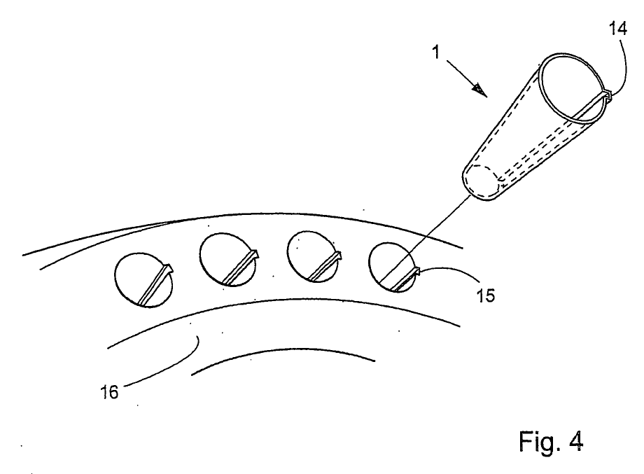

A particular embodiment of the invention is a combination of a vessel having an external feature in the shape of a longitudinal edge, or an edge, notch or similar, said feature corresponding to a feature of the hole in the rotor or part thereof, receiving and holding said vessel. The presence of said features ensures that each vessel is correctly orientated in the rotor, with respect to the direction of rotation and the direction of the g-force during centrifugation. Optionally, said features are such, that only vessels having a particular feature, e.g. a notch, will fit in the holes in the rotor, e.g. holes having a corresponding constriction. Another option is such, that the features of the holes in the rotor are such, that vessels requiring a pre-defined position, will only be possible to insert in such position, while vessels not requiring a particular positioning, can be freely inserted. This embodiment is illustrated in FIG. 4, where the longitudinal edge 14 corresponds to a notch 15, in each hole in a rotor 16.

Another embodiment of the invention is a vessel having internal features, influencing or interacting with the flow in the vessel. This embodiment is also illustrated in FIG. 3a through c, where the one or more of the features 2, 3, 4, 5, 6, and 8 on the inner surface of the vessel 1, as well as features 10, 11, 12, or 13 on the surface of an insert 9, suitable for positioning in the vessel 1, is such a feature. Examples of topographical features on the inside of the vessel, interacting with the flow, include negative features, such as indentations, dimples, dents, scratches, notches etc, or positive features, such as points, dots, specks, corrugated areas, matted surfaces etc. According to a specific embodiment, said positive or negative features are combined with immobilised reagents, substrates or other chemical properties, designed to maximise mass transport between said reagents etc and the bulk of the liquid in the vessel during the flow conditions created according to the present invention.

The present invention also makes available a device for performing the rapid mixing and homogenisation, as well as for creating the flow pattern within the reaction vessel. Such device requires means for holding at least one but preferably a multitude of reaction vessels, and means for subjecting these to centrifugation. Preferably such means consist of a rotor, e.g. a rotor chosen among the following: a drum rotor, a swing-bucket rotor and a fixed angle rotor.

Further, said device requires means for creating a temperature difference within the reaction vessel or vessels, preferably asymmetrically heating the contents of, and most preferably heating a sub-portion of said contents, preferably the central portion of the reaction mixture. Said means can be any heating source, capable of heating the contents and preferably a subset of the contents of the reaction vessels, e.g. a radiating source, such as a heating element with electric resistance wires, an IR-source, a microwave element and the like. Preferably said heating means are heating means capable of focusing the heat to a sub-portion of the reaction mixture, such as the central portion thereof.

Further, said device requires means for cooling the outside of the reaction vessel. The cooling source or means for cooling can be chosen among convection cooling and a circulating cooling medium, e.g. a refrigerated gas, such as air and preferably nitrogen. In an embodiment, such as those shown in the attached drawings, the cooling medium is let into the mantle and thus comes in contact with the rotating reaction vessels. According to another embodiment, the environment of the rotor is refrigerated with exception of the mantle. By moving the mantle in relation to the rotor, e.g. raising or lowering it into close proximity of the rotating reaction vessels, said vessels are heated. By lowering, raising or otherwise removing the mantle, the surrounding cold environment is again allowed to contact the rotating reaction vessels. Instead of moving the mantle, the rotor can be moved while the mantle is kept at a fixed position.

Further, the device preferably includes means for temperature measurement. With an IR sensor or other rapid sensor, an on-line measurement of temperature is obtained. When using fact that the rapid mixing and homogenisation is achieved also at very small temperature differences in the reaction mixture, the need for fast and accurate temperature measurement is reduced. When using higher temperatures, the need for fast and accurate temperature measurement is greater.

### EXAMPLES

In preliminary studies, microcentrifuge tubes having a volume of 50 μl were centrifuged at a speed of 10,000 rpm. The sample had an initial temperature of 90° C. and the gas surrounding the rotor was kept at 10° C. The temperature difference was approximated to be about 75° C., when the properties of the thermoplastic microcentrifuge tube had been taken into account. Under these conditions, it was found that complete homogenisation was achieved in fractions of a second. Theoretical calculations indicate, that flow velocities in the excess of 1 to approximately 1.5. m/s are reached in thin fluid layers. This is a surprisingly high velocity, and based on this, it can be shown that the homogenisation with respect to temperature, concentration etc in the volume of the vessel, as well as the mass transfer between the bulk of said vessel and its surface will be greatly enhanced.

Further calculations show that the flow velocity is linearly dependent on the temperature difference, indicating that the rapid homogenisation and mass transport will be achieved also at lower temperature differences. It is also estimated that the inventive flow pattern is achieved in a very wide volume interval, ranging from extremely small volumes such as volumes enclosed in vessels, compartments and channels having a diameter of about 10 μm and upwards, as well as in larger volumes, and even volumes in the order of about 10 ml and more. The flow pattern is however believed to enter a more turbulent stage with increasing vessel volume. Preferably the inventive homogenisation and mass transport is applied to reaction mixtures in volumes in the interval of about 1 μl to 1 ml, preferably about 10 μl to about 500 μl, and most preferably 50 μl to about 150 μl.

With regard to speed of centrifugation, it is estimated that the inventive homogenisation and mass transport is achieved already at rotational speeds about 1000 rpm, whereas a practical interval is held to be about 5,000 to about 15,000 rpm, preferably about 6,000 to about 12,000 rpm.

At lower speeds, the effectiveness of the inventive homogenisation and mass transport is reduced. The same is believed to be the case for small volumes, where the properties of the liquid in question, as well as the geometry of the vessel will become limiting factors. It is however conceived, that there are applications, where even a lover degree of the inventive homogenisation and mass transport will represent an improvement over existing methods.

Although the invention has been described with regard to its preferred embodiments, which constitute the best mode presently known to the inventors, it should be understood that various changes and modifications as would be obvious to one having the ordinary skill in this art may be made without departing from the scope of the invention which is set forth in the claims appended hereto.

1. A method for rapid homogenisation of reaction mixtures with respect to temperature and chemical concentration, the reaction mixture being placed in a vessel suitable for centrifugation, and subjected to asymmetric heating, cooling and simultaneous centrifugation, characterized in that said asymmetric heating and cooling consists in the creation of a temperature difference between subsets of said reaction mixture, and the centrifugation is performed at conditions sufficient for creating an enhanced flow within said reaction mixture, wherein said flow ensures practically total mixing and homogenisation of the reaction mixture.

2. The method according to claim 1, wherein the asymmetric heating and cooling consists of the walls of the reaction vessel being cooled, while a portion of the reaction mixture is heated.

3. The method according to claim 1, wherein the central portion of the reaction mixture is heated while the walls of the reaction vessel are being cooled.

4. The method according to claim 1, wherein the reaction mixture is subjected to a centrifugal force exceeding 500×g.

5. The method according to claim 1, wherein the reaction mixture is subjected to a centrifugal force in the interval of about 500 to about 20,000×g.

6. The method according to claim 1, wherein the reaction mixture is subjected to a centrifugal force in the interval of about 1,500 to about 20,000×g.

7. The method according to claim 1, wherein the reaction mixture is subjected to a centrifugal force in the interval of about 5,000 to about 15,000×g.

8. The method according to claim 1, wherein the heating of a subset of the reaction mixture is performed by a method of heating chosen among an IR-source, and a microwave element.

9. The method according to claim 2, wherein the cooling of the walls of the reaction vessel is performed by convection cooling or the use of a circulating cooling medium.

10. A method for enhancing mass transport between a surface and the bulk of a solution, in contact with said surface, characterized in that said solution is placed in a vessel suitable for centrifugation, and subjected to asymmetric heating, cooling and simultaneous centrifugation at conditions for creating a enhanced flow within said reaction mixture, wherein the asymmetric heating and cooling consists in the creation of a temperature difference between subsets of said reaction mixture and said flow ensures practically total mixing and homogenisation of the reaction mixture.

11. The method according to claim 10, wherein the asymmetric heating and cooling consists of the walls of the reaction vessel being cooled, while a portion of the reaction mixture is heated.

12. The method according to claim 10, wherein the central portion of the reaction mixture is heated while the walls of the reaction vessel are being cooled.

13. The method according to claim 10, wherein the reaction mixture is subjected to a centrifugal force exceeding 500×g.

14. The method according to claim 10, wherein the reaction mixture is subjected to a centrifugal force in the interval of about 500 to about 20,000×g.

15. The method according to claim 10, wherein the reaction mixture is subjected to a centrifugal force in the interval of about 1,500 to about 20,000×g.

16. The method according to claim 10, wherein the reaction mixture is subjected to a centrifugal force in the interval of about 5,000 to about 15,000×g.

17. The method according to claim 10, wherein the heating of a subset of the reaction mixture is performed by a method of heating chosen among an IR-source, and a microwave element.

18. The method according to claim 11, wherein the cooling of the walls of the reaction vessel is performed by convection cooling or the use of a circulating cooling medium.

19. A method for performing chemical synthesis, comprising the method of claim 1.

20. A method for performing chemical synthesis, comprising the method of claim 10.

21. A method according to claim 19, wherein the chemical synthesis is solid phase chemical synthesis.

22. A method for performing an assay, comprising the method of claim 1.

23. A method for performing an assay, comprising the method of claim 10.

24. A method according to claim 22, wherein the assay is a solid phase assay.

25. A method for rapid temperature inactivation in chemical reactions, wherein the reaction mixture is subjected to the method according to claim 1, the entire reaction mixture being rapidly brought to a temperature sufficient to perform the desired inactivation.

26. A device for performing the method according to claim 1, wherein said device has means for holding a vessel suitable for centrifugation, and means for subjecting said vessel to asymmetric heating, cooling and simultaneous centrifugation at conditions for creating an enhanced flow within said reaction mixture, wherein said flow ensures practically total mixing and homogenisation of the reaction mixture in said vessel.

27. A device for performing the method according to claim 10, wherein said device has means for holding a vessel suitable for centrifugation, and means for subjecting said vessel to asymmetric heating, cooling and simultaneous centrifugation at conditions for creating an enhanced mass transport between the bulk of reaction mixture and the surface of said vessel, wherein said flow ensures that the entire bulk of the reaction mixture repeatedly passes a defined location in the vessel.

28. A reaction vessel (1), the configuration of which takes into account the flow pattern achieved in said vessel during asymmetric heating and cooling during centrifugation.

29. The reaction vessel (1) according to claim 28, wherein said vessel has means (2, 3, 4, 5, 6, 7, 8, 9) capable of interaction with at least one component of the reaction mixture, placed at locations at the inner surface of the reaction vessel, corresponding to the collective down-ward flow or sink in said vessel.

30. A reaction vessel (1) according to claim 28, wherein said vessel has a shape or features (14) which aid in the positioning of said vessel so that the flow pattern achieved in said vessel during asymmetric heating and cooling thereof during centrifugation is accounted for, and so that the location of the collective down-ward flow or sink in said vessel can be controlled.

31. The reaction vessel according to claim 28, wherein said reaction vessel is chosen among a centrifuge tube, a microtitre tube, a well in a microtitre plate, a volume defined in a device suitable for rotation, such as a platform for analysis in the CD-format.

32. The reaction vessel according to claim 29, wherein said means capable of interaction with at least one component of the reaction mixture are means chosen among mechanical means interacting with the flow, means for transferring heat, means for guiding light or radiation, arrays, defined areas, dots or spots with a chemical or biochemical component which interacts with a component in the reaction mixture.

33. An insert (9) for a reaction vessel (1) for use in a method according to claim 1, characterized in that said insert has means (10, 11, 12, 13) capable of interaction with at least one component of the reaction mixture, placed at locations at the surface of said insert, corresponding to the collective down-ward flow or sink in said vessel, when said insert is in place in said vessel.

34. The insert according to claim 33, wherein said means capable of interaction with at least one component of the reaction mixture are means chosen among mechanical means interacting with the flow, means for transferring heat, means for guiding light or radiation, arrays, defined areas, dots or spots with a chemical or biochemical component which interacts with a component in the reaction mixture.

35. A reaction vessel comprising, as a detachable or integrated part thereof, an insert according to claim 33.
